(19) United States
(12) Patent Application Publication
(10) Pub. No.: US 2011/0214352 A1
(43) Pub. Date: Sep. 8, 2011

(54) CURTAIN-TYPE CLOSURE DEVICE FOR AN OPENING IN A BUILDING

(75) Inventor: Ignace Bellota, Laroin (FR)

(73) Assignee: A.S.A. FERMETURES, LESCAR (FR)

(21) Appl. No.: 13/055,570

(22) PCT Filed: Jul. 2, 2009
(86) PCT No.: PCT/EP2009/058339

§ 371 Date: May 25, 2011

(30) Foreign Application Priority Data
Jul. 3, 2008 (FR) 0803770

(51) Int. Cl. E05D 15/18

(52) U.S. Cl. 49/197

(57) ABSTRACT

A closing device for an aperture in a building includes a guide structure provided with a vertical pair of guide rails and/or an apron in the form of a flexible curtain, movable in the guide structure between an opening position of the aperture and a closing position under the effect of the action of a motorized drive unit including traction cables. The lower part of the apron is formed by a rigid blocking wall to which the traction cables are attached. The upper part of the apron is formed by a flexible blocking wall and is attached by its horizontal lower edge to the rigid blocking wall and by its horizontal upper edge to the lintel of the aperture. In the opening position, the apron is folded onto itself in the upper part of the guide rails, whereby this upper part is horizontal or inclined relative to the horizontal.

### TECHNICAL FIELD

This invention is of the field of equipment used to ensure the closing of apertures in buildings and relates more particularly to a quick-closing device with a movable flexible curtain.

### PRIOR ART

From the prior art, closing devices with a movable flexible curtain from bottom to top and vice versa are known whose advantage, because of their lightness, is to allow quick opening and closing movements (displacement speed of between one meter per second and three meters per second).

More particularly, a closing device is known that comprises a flexible curtain that is stiffened by a series of uniformly spaced horizontal stiffeners, engaged by its two lateral edges in two vertical boxes of a framing structure that borders the lateral edges of the aperture as well as the upper edge of the latter. By its upper part, the curtain is engaged in a horizontal upper box that is supported by two lateral boxes. In the folded position of the curtain, the stiffeners are laterally juxtaposed in the upper part in the horizontal upper box of the framing structure, and the curtain forms a series of folds under these stiffeners in the width of the vertical boxes.

The drawback of such a solution is that it requires a box width and therefore a space on the ground that is all the more significant since the curtain comprises stiffeners; in practice, this limits their number or their size.

Another drawback of this type of device sticks to the fact that its mounting and its installation are long and tedious and particularly expensive operations.

A door structure that is movable in the vertical direction is also known from the patent application WO 88/03217. This folding door structure comprises a door panel that is divided into a series of horizontal panels constituted by rigid panels that alternate with flexible fabric panels, each of the rigid panels being mounted by its ends in a guide rail pair that is specific thereto. The guide rail pairs are juxtaposed according to the depth of the opening, and their number depends on the flexible panel number. Thus, the thickness of the door structure, and therefore the space on the ground of the latter, depends on the rigid panel number.

This door structure comprises a means for opening and closing maneuvers constituted by a winching device that is formed by a toothed drive belt or an endless chain stretched between an upper pulley and a lower pulley, whereby the upper pulley is coupled to a drive shaft engaged with the output shaft of a drive element. The lower rigid panel is attached to the endless belt. The drawback of such an arrangement resides in the risk of deterioration of the flexible fabric panels and in particular of the lower flexible panel. Actually, during the maneuvering while opening the door, the latter absorbs the weight of the upper panels.

Finally, it should be noted that such a door structure requires a lintel drop that is equal to at least the height of each panel, which limits its field of application, whereby the lintel drop is the normal distance between the ceiling and the lower surface of the lintel.

A door structure whose apron is formed by a series of rigid panels, each mounted to slide in a dedicated guide rail pair, is known from U.S. Pat. No. 3,313,338. The guide rail pairs are arranged in a juxtaposed manner, and their number, equal to the panel number, consequently increases the space on the ground. The lower panel works with an actuating mechanism while opening and closing, comprising traction cables, and each panel has a drive jaw secured to act by thrusting on a jaw of the panel that is immediately above it so as to drive the latter upward during the opening movement. In the wide-open position, the panels are in a juxtaposed state above the opening.

### DISCLOSURE OF THE INVENTION

Heretofore, the term “rigid” defines an element or an assembly that does not become significantly deformed under the effect of its weight and/or loads that are applied thereto and that substantially preserves its geometry regardless of the spatial position that it occupies and the direction and the intensity of the forces to which it is subjected, it being understood that these forces remain within the limits imposed by normal operation.

The object of this invention is to solve the above-mentioned problems by proposing a closing device that implements another method for folding the flexible curtain that leads to reducing the space on the ground of the framing structure, this hold remaining independent of the number of stiffeners and panels used.

Another object of this invention is the implementation of a closing device with a curtain that can be used even with small lintel drops and following the slopes of roofs.

Another object of this invention is to propose a closing device with a curtain with facilitated mounting and implementation.

For this purpose, the closing device according to the invention for the aperture in a building that comprises a guide structure that is formed by at least partially vertical or at least partially substantially vertical guide rails, fixed against the aperture in a building and an apron in the form of a flexible curtain that can move in the guide structure between an opening position and a closing position of the aperture and vice versa by the action of a drive means that is motorized with traction cables, is characterized essentially in that:
The lower part of the apron is formed by a rigid blocking wall to which the traction cables are attached,
The upper part of the apron is formed by least one flexible blocking wall and is attached by its horizontal lower edge to the blocking wall and by its horizontal upper edge to the lintel of the aperture.

In the closing position, the rigid blocking wall of the apron rests on the threshold of the aperture, and the flexible blocking wall of the apron occupies an extension state that is optionally under slight tension between the rigid blocking wall and the lintel of the aperture. For the opening of the aperture, the rigid blocking wall is driven upward by the drive means, and the flexible blocking wall, during this movement—under the action in particular of its weight—laterally folds onto itself at the rigid blocking wall. The movement of the rigid blocking wall along the guide structure continuing, the horizontal lower edge of the lower part of the apron is brought to occupy a level that is higher than or identical to the level that is occupied by its upper edge. This upper part of the apron then occupies an upper position above the aperture.

According to another characteristic of the invention, each guide rail has a vertical rail segment that is essentially vertical and an upper rail segment, occupying a horizontal or essentially horizontal spatial position by being inclined upward or an inclined position relative to the vertical, whereby this segment is provided to receive the apron in the opening position of the aperture, the apron being folded onto itself in this position.

Because of these arrangements, the installation of the closing device according to the invention can be carried out even with a small lintel drop.

According to another characteristic of the invention, the upper part of the apron is formed by a one-piece flexible wall, but, according to a variant embodiment, the upper part of the apron is formed by at least two flexible blocking walls and by at least one rigid blocking wall that is inserted between the two flexible blocking walls.

According to another characteristic of the invention, the rigid blocking wall comprises an upper pair of guide rollers and a lower pair of guide rollers that are both engaged in the same pair of guide rails.

According to a variant embodiment of the device according to the invention, the upper part of the apron is formed by at least two flexible blocking walls and by at least one rigid blocking wall that is inserted between the two flexible blocking walls.

With such an embodiment, the or each rigid blocking wall comprises a pair of upper guide rollers working in guiding with the same first pair of guide rails and a pair of lower guide rollers working with a second pair of guide rails that is adjacent to the preceding pair and arranged between the aperture and the first pair of guide rails.

According to another characteristic of the invention, the apron comprises a rigid blocking wall that forms its lower part, and at least one other rigid blocking wall that is distant from the preceding wall in the closing position of the aperture, whereby each rigid wall comprises at least one thrust means and whereby the thrust means of each blocking wall works in a thrusting manner with the thrust means of the wall that is immediately above it and/or the blocking wall that is immediately below it so that during its upward movement, each wall that is immediately below it drives the wall that is immediately above it toward the opening position.

According to another characteristic of the invention, the thrust means that each rigid wall has is supported by the upper edge of said wall and forms a lateral projection relative to the latter; the upper pair of rollers is offset laterally relative to the upper edge of said rigid wall from the same side as the projection that forms the thrust means; and the normal distance between the upper edge of said rigid wall and the axis of rotation of the rollers of the upper pair of rollers increases from the lower rigid blocking wall to the upper rigid blocking wall.

The object of such an arrangement is to facilitate the juxtaposition of the rigid blocking walls during the opening movement.

According to another characteristic of the invention, the or each flexible blocking wall comprises at least one horizontal stiffener for imparting to said wall a certain rigidity in terms of the width of the opening that determines the aperture. Such an arrangement applies in particular to devices for blocking apertures of large width.

According to another characteristic of the invention, the stiffener projects laterally beyond the corresponding flexible wall and is engaged by its ends in a dedicated pair of rails.

According to another arrangement of the invention, at least one elastic cable, attached to the horizontal upper and lower edges of said wall, is associated with each flexible blocking wall, whereby said cable rests on one of the surfaces of said wall and on the associated stiffener, and at least in the extended position of said flexible wall, said cable being extended between the upper and lower edges of said wall.

This arrangement is conducive, during opening, to promoting the formation of folds of the flexible wall from one side or the other and not randomly from two sides of the vertical plane that this wall determines in the closing position.

Furthermore, this arrangement, in the closing position of the aperture, ensures that the stiffener that is applied against the guide structure is held in place.

According to another arrangement of the invention, the elastic cable is also attached to the stiffener.

Because of this characteristic, the stiffener, during the opening movement of the aperture, under the effect of the traction force that the elastic cable applies to it, is pulled upward in its lateral guide rails. This characteristic combined with a divergent arrangement of the guide rails of the stiffener and the rigid frame makes it possible to offset the stiffener laterally from the path of the rigid frame and during opening or closing, thus preventing the friction of the part of the apron developing under the stiffener.

According to another characteristic of the device according to the invention, the or each rigid blocking wall is formed by a rigid frame that comprises at least one horizontal longitudinal beam that occupies an upper position and two vertical lateral crosspieces that are attached to the longitudinal beam and that extend downward from the latter, whereby this rigid frame receives a filling wall.

According to another characteristic of the invention, the rigid frame comprises a rigid lower longitudinal beam that is attached by its ends to its two vertical crosspieces, however, according to another embodiment, the rigid frame does not comprise a lower longitudinal beam, but by replacement, a horizontal elastic link, mounted under tension between the two vertical crosspieces of the frame.

For such an embodiment, for the purpose of ensuring its rigidity, the frame will comprise an intermediate horizontal long beam, attached to the two horizontal crosspieces, at a distance from their lower end.

A rigid frame arrangement with an elastic link in the lower part offers the advantage of eliminating or greatly reducing the risks of serious injuries to an individual who is in the path of the apron during its closing movement.

Another advantage is to reduce the risks of damage to the rigid frame under the effect of an impact on the latter because of, for example, a moving object traveling through the opening of the aperture.

Finally, according to another characteristic of the invention, the rigid frame can be formed by two particles that are articulated with one another along a horizontal axis. This arrangement is conducive to facilitating the travel of the lower part of the apron along a curved rail part.

### SUMMARY DESCRIPTION OF THE FIGURES AND DRAWINGS

Other advantages, objects, and characteristics of the invention will emerge in reading the description of a preferred embodiment that is provided by way of nonlimiting example by referring to the accompanying drawings in which:

FIG. 1 is a front view, in diagrammatic form, of an aperture that is outfitted with a device, in closing position according to a first embodiment,

FIG. 1a is a detail view of the rigid wall that constitutes the lower part of the apron of the device according to the invention,

FIG. 2 is a profile view, in diagrammatic form, of an aperture that is outfitted with the device according to the first embodiment, in closing position,

FIG. 3 is a profile view, in diagrammatic form, of the device according to the first embodiment, in the process of opening,

FIG. 4 is a profile view, in diagrammatic form, of the device according to the first embodiment, in the wide-open position,

FIG. 5 is a front view, in diagrammatic form, of an aperture that is outfitted with a device, in closing position according to a second embodiment,

FIG. 6 is a profile view, in diagrammatic form, of an aperture that is outfitted with the device according to the second embodiment, in closing position,

FIG. 7 is a profile view, in diagrammatic form, of the device according to the second embodiment, in the process of opening,

FIG. 8 is a profile view, in diagrammatic form, of the device according to the second embodiment, in the wide-open position,

FIG. 9 is a front view of another embodiment of the device according to the invention,

FIG. 10 is a profile view of the device according to FIG. 9,

FIG. 11 is a front view of another embodiment of the device according to the invention,

FIG. 12 is a transversal cutaway view of the guide structure and the apron.

### BEST WAY TO IMPLEMENT THE INVENTION

As shown, the closing device 1 for the aperture 2 of a building comprises a guide structure 3 that is attached to the jambs of the aperture and the latter laterally to the opening 20 that the latter determines and an apron 4 in the form of a flexible curtain that can move in the guide structure 3 between an opening position and a closing position of the aperture, whereby this guide structure comprises a pair of guide rails 30.

Each guide rail 30 has a common vertical or essentially vertical lower rail segment 30a at least over the entire height of the aperture 2 and an upper rail segment 30b that occupies a horizontal or essentially horizontal spatial position by being inclined upward so as to follow the slope of the roof structure, or a position that is inclined relative to the vertical, whereby this segment is provided for receiving the apron 4 in the opening position of the aperture 2. The segment 30b of each rail 30 is located partially or totally above the opening of the aperture.

The apron 4 can move between the two above-mentioned positions under the effect of the action of a motorized drive means 5.

The drive means 5, without this being limiting, can consist of a horizontal winding bar 50 that is mounted above the opening of the aperture, in two end bearings 51, and optionally in one or more intermediate bearings. An electric motor 52 is linked to this winding bar. At least two winding drums, spaced apart, of two drive cables 54 of the apron 4 are attached to this bar.

As can be seen in FIG. 12, each drive cable 54 can be housed in the guide structure and will be attached by its lower end to the apron 4 by means of a suitable element, such as a foot, etc. This element can also be the body of an anti-drop mechanism that is integral with the apron 4.

As a variant, the drive cable can consist of a strap. The electric motor 52 can have hard-wire, radio-frequency or infrared control.

According to the invention, the lower part 40 of the apron 4 is formed by a rigid blocking wall that is made of one or more parts that are articulated to one another. This lower wall preferably consists of a rigid frame 40a that defines a rectangular contour to which the traction cables 54 are attached, whereby this rigid frame receives a filling wall 41. The two traction cables are attached to the lower part of the rigid wall 40 by the means described above.

The rigid frame 40a that constitutes the rigid wall 40 is formed by at least one upper horizontal longitudinal beam and by two vertical, lateral crosspieces that are attached to the upper longitudinal beam and that extend downward from the latter. The or each longitudinal beam as well as each crosspiece can consist of steel or else of synthetic material. The filling wall 41 is preferably flexible and preferably consists of a tarpaulin that is impermeable to air and water. This filling wall is attached in a sealed manner to longitudinal beams and crosspieces of the rigid frame 40a.

The upper part 45 of the apron is formed by at least one flexible wall in the form of a fabric or tarpaulin that is preferably impermeable to water and air and that is attached in a sealed manner, by its horizontal lower edge, to the rigid blocking wall 40 and always in a sealed manner by its horizontal upper edge to the lintel 21 of the aperture 2. Advantageously, the height of the flexible wall 45 is greater than or equal to the height of the rigid wall 40.

In the blocking position of the opening 20 of the aperture 2, the rigid blocking wall 40 rests with its lower edge against the threshold of the opening and by its two longitudinal beams, crosspieces and filling wall 41 rests against the jambs of the aperture outside of the opening 20. In this position, the upper part 45 of the apron 4 is vertically deployed and is stretched between the lintel and the frame 40a of the wall 40 and—under the effect of this tension—comes to rest against the jambs of the aperture outside of the opening 20. In the wide-open position of the aperture, the apron 4 is folded onto itself and is located above the opening 20 of the aperture 2.

The rigid blocking wall 40 comprises lateral guide means in the form of rollers 42, 43 with horizontal axes of rotation, working in guiding with the guide structure 3. Preferably, the rollers 42 and 43 are arranged in two pairs of rollers, namely one upper pair of rollers 42 and one lower pair of rollers 43.

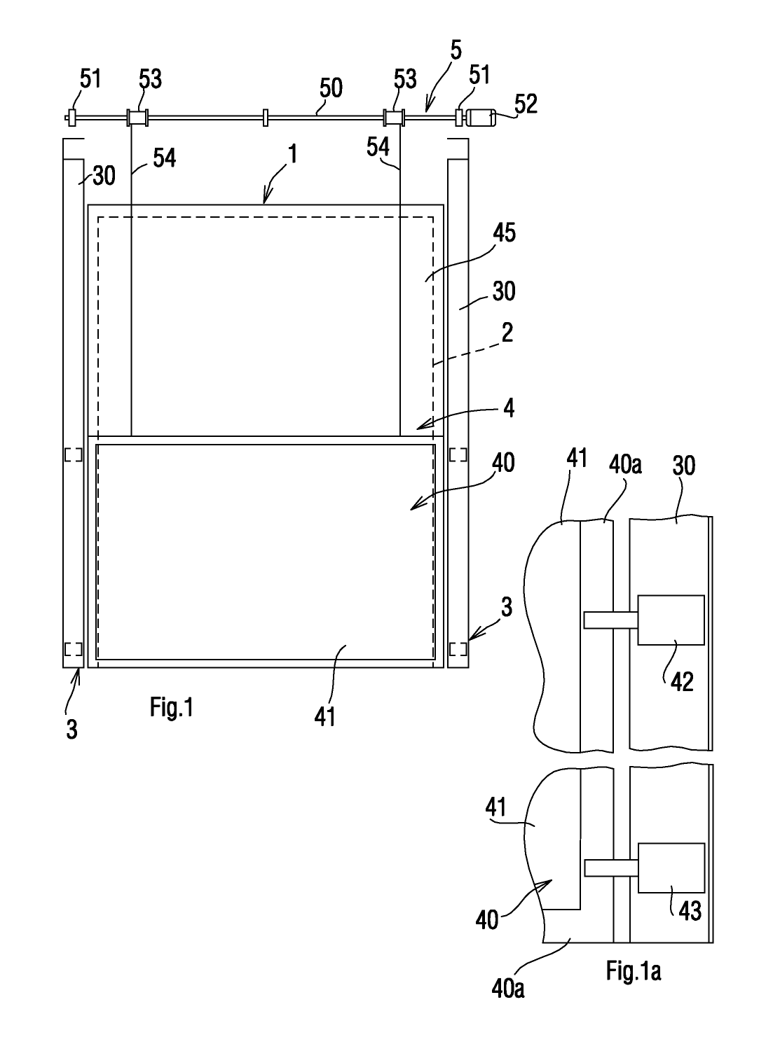

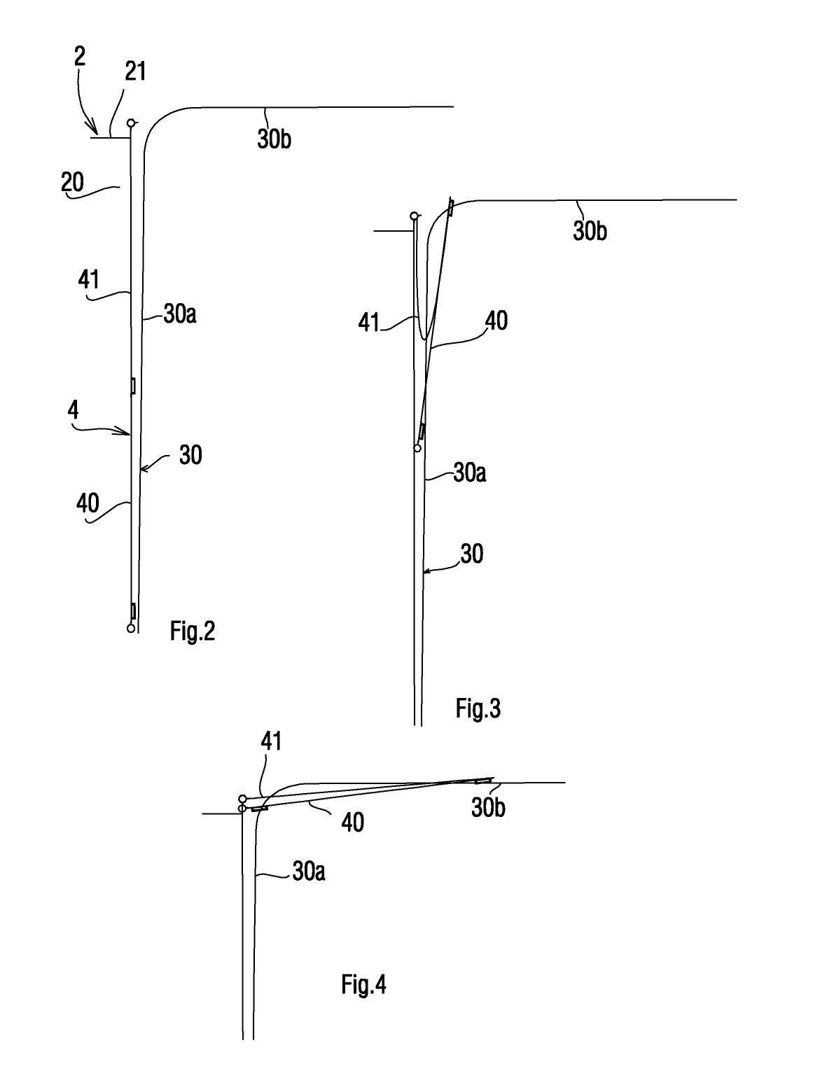

FIGS. 1 to 4 show a closing device according to a first embodiment. In these figures, a device is observed whose upper part of the apron 4 is integrally formed by a one-piece flexible wall 45. It is observed in these figures that the height of the rigid frame is slightly lower than the height of the flexible wall 45.

FIG. 3 shows a device according to the first embodiment during the opening movement. During this movement, the lower part of the apron, i.e., the rigid blocking wall 40, moves in the pair of guide rails 30 in an upward movement that is generated by the traction exerted by the cables 54 under the effect of their winding on the drums 53 of the winding bar 50 that is actuated in rotation for this purpose by the engine element 52. In this figure, it is noted that the flexible wall 45 folds onto itself under the effect of its weight, laterally to the rigid blocking wall 40, between the latter and the opening 20 of the aperture 2.

FIG. 4 shows a device according to the first embodiment in the wide-open position of the aperture. In this position, the apron is folded onto itself in the parts 30b of rails 30. It is observed that the rigid blocking wall 40 is arranged for the most part in the upper segment 30b of each guide rail 30 and that the flexible wall 45 is held by tension between the lintel of the aperture 20 and the corresponding longitudinal beam of said rigid wall 40.

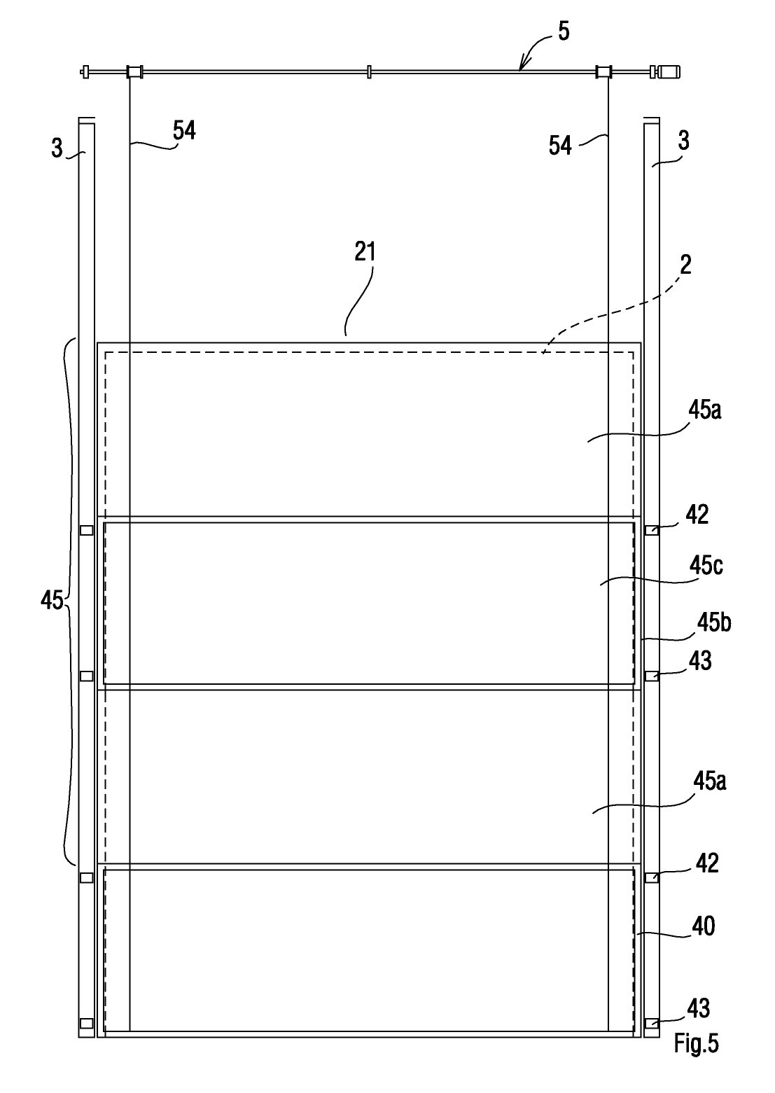

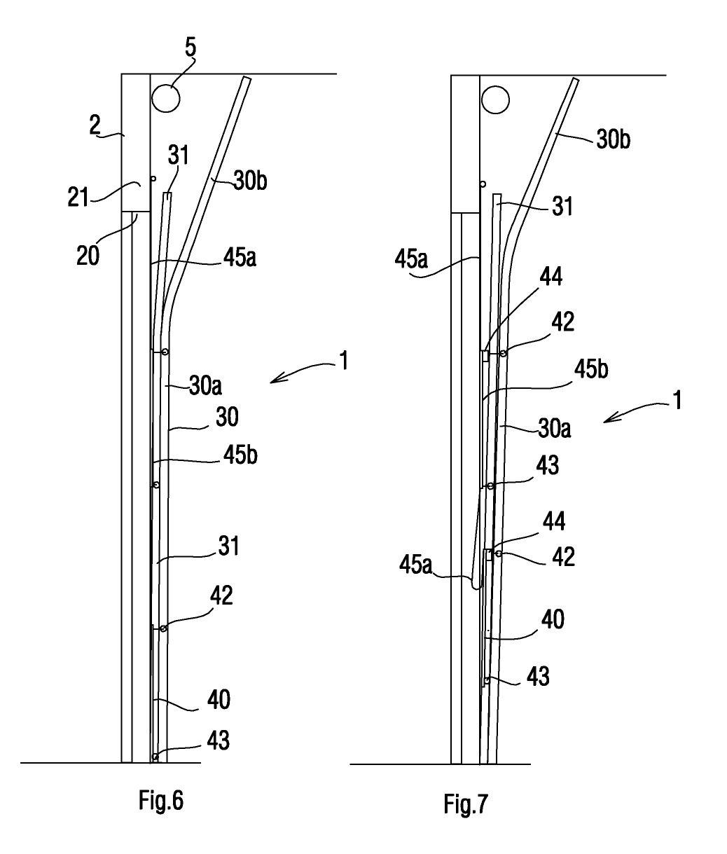

FIGS. 5 to 8 show a device according to a second embodiment. The upper part 45 of the apron 4 is formed by at least two flexible blocking walls 45a that are rectangular in shape and by at least one rectangular rigid blocking wall 45b, inserted between the two flexible walls 45a. The rigid blocking wall 45b consists of a rigid frame that receives a filling wall 45c. This rigid frame being identical to the frame 40a, it will not be described in detail. Just like the rigid blocking wall 40, the rigid blocking wall 45b has an upper pair of guide rollers 42 and a lower pair of guide rollers 43.

In this embodiment, the upper pairs of guide rollers 42 of the rigid blocking walls 40 and 45b are engaged in one and the same first pair of guide rails 30, and the lower pairs of the guide rollers 43 of the rigid blocking walls 40 and 45b are engaged in one and the same second pair of guide rails 31 adjacent to the preceding and arranged between the aperture 2 and the first pair of rails 30.

Furthermore, each rigid blocking wall 40, 45b comprises at least one thrust means 44, and the thrust means of each wall 40, 45b works in a thrusting manner with the thrust means of the rigid wall that is immediately above it and/or the rigid wall that is immediately below it so that during its upward movement, each wall that is immediately below it then drives the rigid wall that is immediately above it toward the opening position.

According to the preferred embodiment, the thrust means 44 that each rigid wall 40, 45b has is supported by the upper longitudinal beam of the rigid frame of this wall and forms a lateral projection relative to the latter. Still according to this embodiment, the upper pair of rollers is offset laterally relative to the upper longitudinal beam of the rigid frame of the corresponding wall from the same side as the projection that forms the thrust means 44. Finally, still according to this embodiment, the normal distance between the upper longitudinal beam of the frame and the axis of rotation of the rollers of the upper pair of rollers increases from the lower rigid wall 40 to the upper rigid wall 45b.

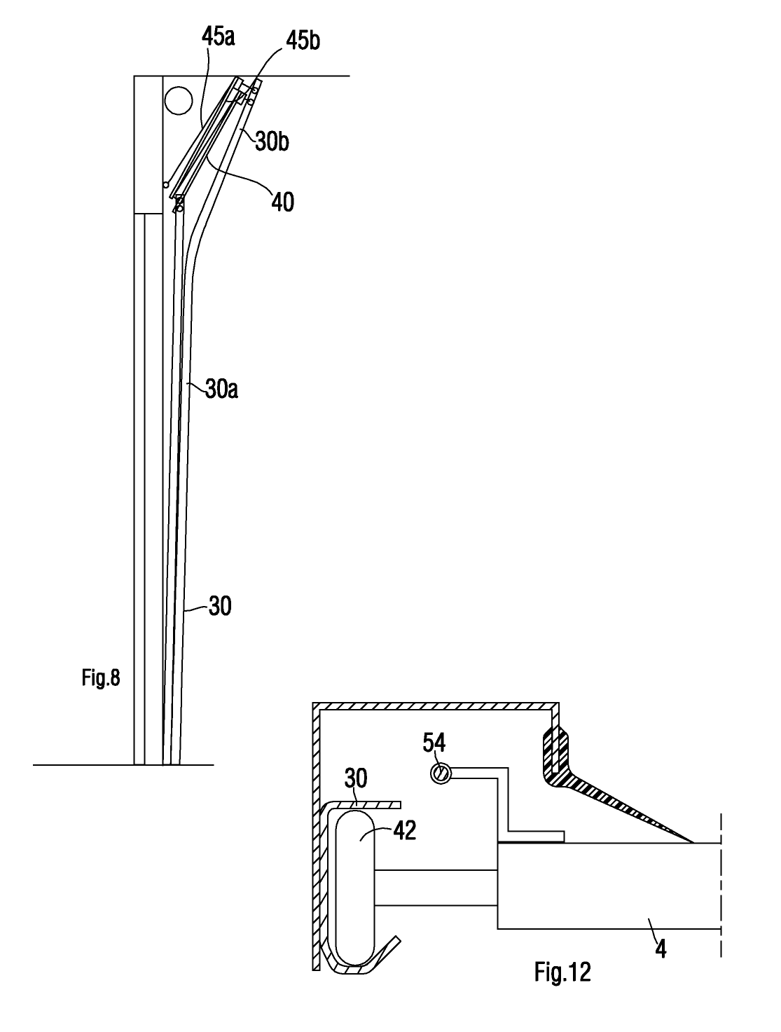

These arrangements, as can be seen in FIG. 7, ensure that when the rigid blocking wall 40 is being driven toward the opening position, the thrust means 44 of the latter will work with the thrust means 44 of the rigid wall 45b that is immediately above it by being positioned laterally relative to the latter and driving it in its upward travel. During its upward travel, this rigid wall 45b can also—by its thrust means 44—work in a thrusting manner with the rigid wall 45b that is immediately above it to drive it toward its opening position by always being positioned laterally relative to the latter. Thus, in a wide-open position, as can be seen in FIG. 8, the different walls 40, 45b are positioned in a juxtaposed manner laterally relative to one another above the opening of the aperture, whereby the apron 4 then occupies a state that is retracted on itself. During the closing movement, the flexible walls fold onto themselves in the same way as described above.

The concept is that with the above-mentioned arrangement, it is possible to use as much of the rigid wall 45b as is necessary without thereby increasing the number of pairs of guide rails 30, 31, this number always remaining equal to two.

It is sometimes necessary to stiffen the flexible wall 45, 45a. For this purpose, the or each flexible wall comprises at least one horizontal stiffener 46 that is attached to said wall in any known manner, at a distance from its upper and lower edges. Preferably, the stiffener occupies a median position between these two edges. This stiffener 46, known in the art, consists of a rectilinear profile with a suitable straight-line cross-section.

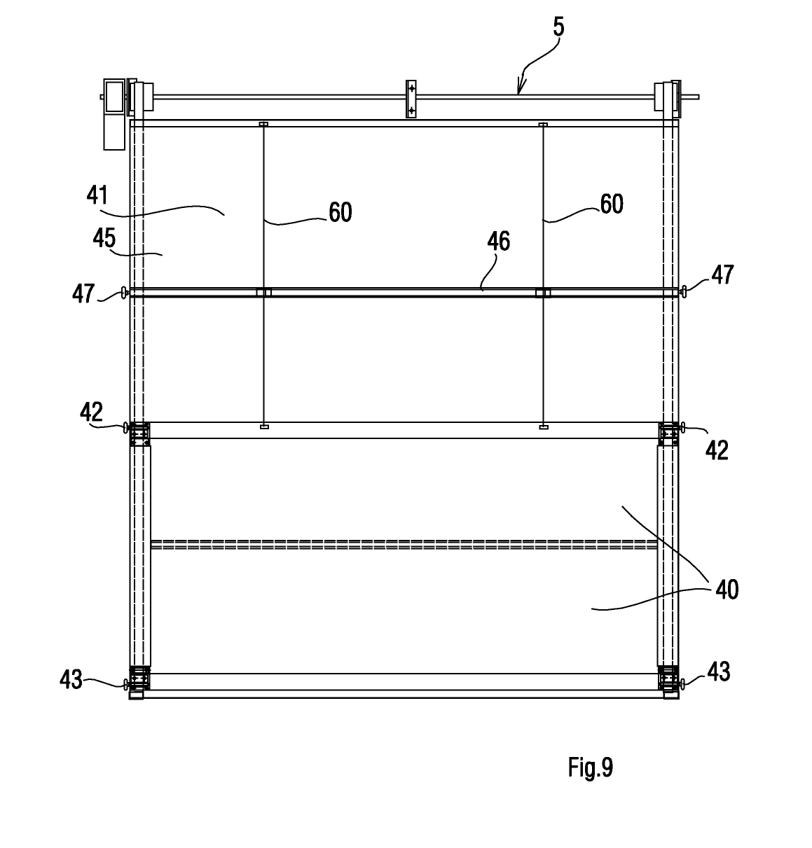

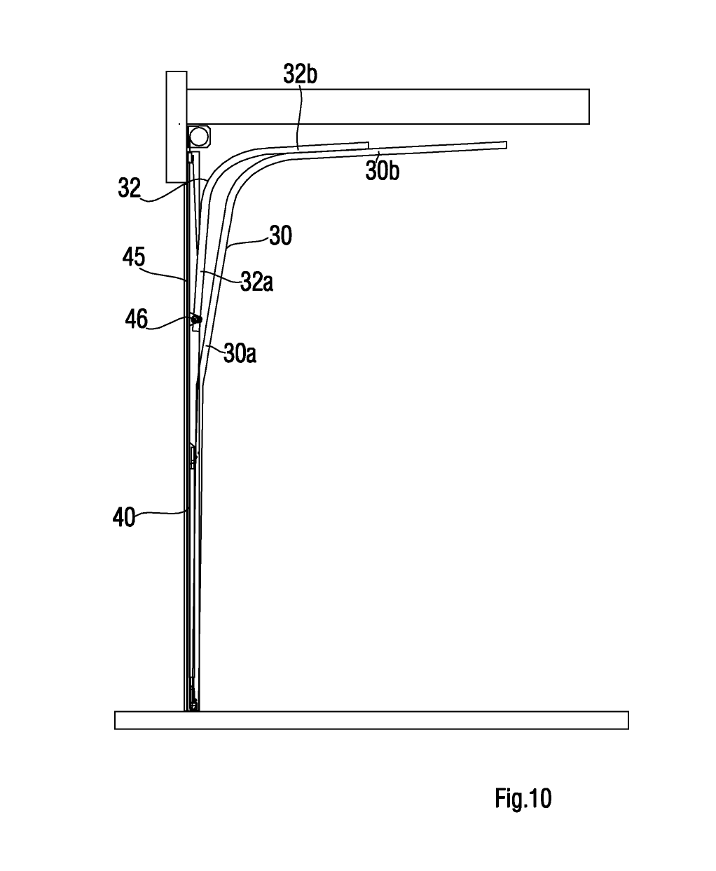

According to this embodiment, the or each stiffener 46 projects laterally beyond the corresponding flexible blocking wall and engages in a dedicated pair of rails 32, common to all of the stiffeners, adjacent to the preceding pair(s) of rails 30, 31. Such an arrangement can be seen in FIG. 9. It is possible to see in this figure that the stiffener 46—at each end—comprises a guide roller 47 that is provided for being engaged in the corresponding rail 32. It should be noted that the rail 32 has no need to occupy the entire height of the aperture, since the stiffener 46, in the wide-open position, is located at a distance from the ground. In this figure, it is observed that each rail 32 has a lower rail segment 32a, essentially vertical and extended by a horizontal or essentially horizontal upper rail segment 32b that is adjacent to the rail segment 30b of the rail 30.

It is also observed in FIG. 9 that the flexible wall 45 or 45a is associated with at least one elastic cable 60, attached to the horizontal upper and lower edges of this wall. This elastic cable 60 expands vertically by resting on one of the surfaces of said wall and on the associated stiffener 46. At least in the extended position of the flexible wall 45, a position that corresponds to the closing of the aperture, the elastic cable 60 is extended between the upper and lower edges of said flexible wall 45.

The same arrangement of stiffener 46 and elastic cable 60 can be applied to the flexible wall 45a of the embodiment that corresponds to FIGS. 5 to 8.

This arrangement during opening forces the formation of folds of the or each flexible wall 45, 45a on one side or the other and not randomly on the two sides of the vertical plane as this wall determines in closing position. Advantageously, the folds will be formed on the side outside of the building, the elastic cable 60 then resting against the surface inside of the building of the or each flexible wall 45, 45a.

It should be noted that this arrangement, in the closing position of the aperture, ensures the holding of the stiffener 46 that is applied against the guide structure.

Advantageously, the elastic cable 60 is attached to the stiffener 46 by any means that is known to one skilled in the art. Thus, the stiffener 46, during the opening movement of the aperture, under the effect of the traction force that the elastic cable 60 applies thereto, is pulled upward in its lateral guide rails 32. This characteristic combined with a divergent spatial arrangement of the guide rail segments 30a, 32a in their upper part makes it possible to laterally offset the stiffener 46 from the path of the rigid wall 40 and thus to prevent any friction on the part of the apron from developing under the stiffener 46.

Another advantage of these arrangements resides in the fact that when the apron 4 is in the wide-open position of the aperture and is supported by a horizontal or essentially horizontal part of the rail pair 30, the or each elastic cable 60 is extended and exerts on the lower part of the apron 4 a force that stresses said apron toward its closing position. Thus, in this way, the movement of the apron or the initiator of the movement of the apron in its rails toward the closing position of the aperture will be thereby facilitated. The advantage of causing this movement of the apron is to offset the risk of unwinding cables whereas the apron is stopped in its rails.

According to the preferred embodiment, two elastic cables 60 that are laterally offset from one another are attached to each flexible wall 45 or 45a.

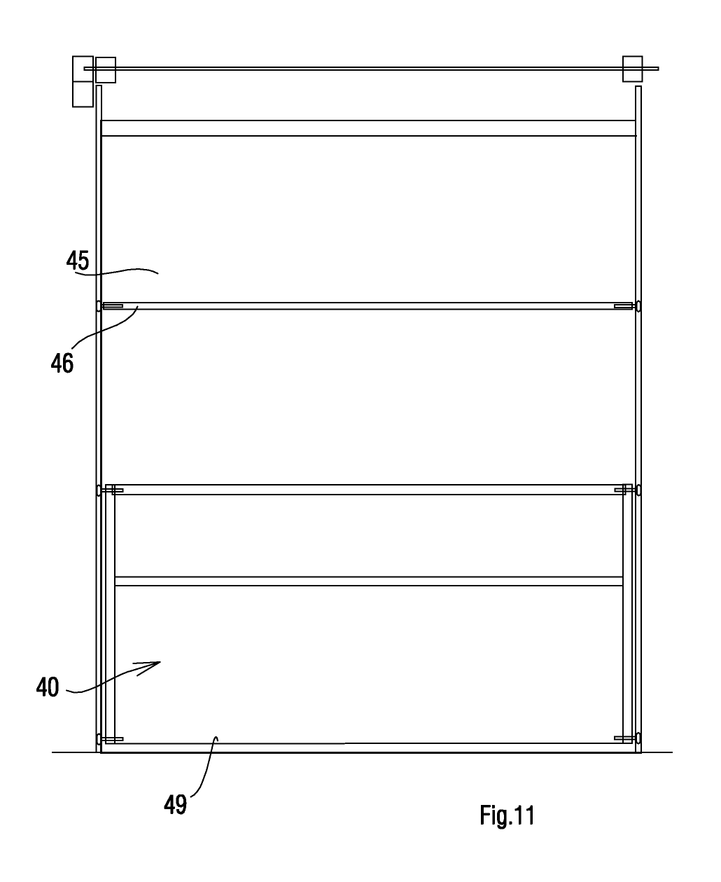

FIG. 11 also shows another embodiment of the device according to the invention. In this figure, it is observed that the rigid frame 40a of the rigid wall 40 does not comprise a rigid lower longitudinal beam but instead a horizontal elastic link 49 that is mounted under tension between the two vertical crosspieces of the frame. Thus, the lower part of the rigid wall 40 is formed by this elastic link 49, the flexible filling wall then also being attached to this elastic link 49.

To ensure its rigidity, the frame 40a of such a wall 40 will comprise an intermediate horizontal longitudinal beam, attached to the two horizontal crosspieces, at a distance from their lower end.

The advantage of such an arrangement is multiple; it makes it possible in particular to avoid seriously injuring an individual who is in the path of the apron during closing, and it reduces the risk of damaging the rigid wall 40 under the effect of an impact on its lower part, because of, for example, a moving object such as a fork-lift, traveling through the opening of the aperture.

Finally, the or each rigid wall 40 and 45b can consist of at least two parts that are articulated with one another along a horizontal axis by a hinge system. Thus, each vertical crosspiece of the frame of this wall will be divided into two crosspiece segments that are joined to one another by a hinge. The two hinges that the frame has will be axially aligned. Guide rollers that will be engaged in the rail pair 30 will be arranged in the axis of the hinge.

An apron 4 whose lower part is formed by a rigid wall that is formed by a frame with a filling wall was described above, but as a variant, the lower part can consist of a rigid rectangular wall that is solid or perforated, performing both the function of rigid frame and filling wall, whereby the rigid frame function is ensured by its peripheral edge on this wall.

It goes without saying that this invention can accommodate all lay-outs and variants of the field of technical equivalents without thereby exceeding the scope of this patent.

1. Closing device (1) for an aperture (2) in a building, comprising a guide structure (3) that comprises at least one vertical or substantially vertical pair of guide rails (30), fixed against the aperture in the building and an apron (4) in the form of an at least partially flexible curtain, movable in the guide structure (3) between an opening position of the aperture and a closing position and vice versa under the effect of the action of a motorized drive means (5) that comprises traction cables (54), characterized in that:
The lower part (40) of the apron (4) is formed by a rigid blocking wall to which the traction cables (54) are attached,
The upper part (45) of the apron (4) is formed by at least one flexible blocking wall and is attached by its horizontal lower edge to the blocking wall (40) and by its horizontal upper edge to the lintel of the aperture (2).

2. Device according to claim 1, wherein each guide rail (30) has a vertical rail segment (30a) that is essentially vertical and an upper rail segment (30b), occupying a horizontal or essentially horizontal spatial position by being inclined upward or an inclined position relative to the vertical, whereby this segment is provided to receive the apron (4) in the opening position of the aperture (2), the apron (4) being folded onto itself in this position.

3. Closing device according to claim 1, wherein the upper part (45) of the apron (4) is formed by a one-piece flexible wall.

4. Closing device according to claim 3, wherein the rigid blocking wall (40) comprises an upper pair of guide rollers (42) and a lower pair of guide rollers (43) that are both engaged in one and the same pair (30) of guide rails.

5. Closing device according to claim 1, wherein the upper part (40) of the apron (4) is formed by at least two flexible blocking walls (45a) and by at least one rigid blocking wall (45b) that is inserted between the two flexible blocking walls (45a).

6. Closing device according to claim 5, wherein the or each rigid blocking wall (40, 45b) comprises a pair of upper guide rollers (42) that work in guiding with one and the same first pair of guide rails (30) and a lower pair of guide rollers (43) that work with one and the same second pair (31) of guide rails adjacent to the preceding and arranged between the aperture and the first pair (30) of guide rails.

7. Closing device according to claim 6, wherein the apron (4) comprises a rigid blocking wall (40) that forms its lower part and at least one rigid blocking wall (45b) that is distant from the preceding wall in the closing position of the aperture, wherein each rigid wall (40, 45b) comprises at least one thrust means (44) and wherein the thrust means of each blocking wall works in a thrusting manner with the thrust means (44) of the wall that is immediately above it and/or the blocking wall that is immediately below it so that during its upward movement, each wall that is immediately below it drives the wall that is immediately above it toward the opening position.

8. Closing device according to claim 7, wherein the thrust means (44) that each rigid blocking wall (40, 45b) has is supported by the upper edge of said wall and forms a lateral projection relative to the latter, wherein the upper pair of rollers (42) is offset laterally relative to the upper edge of said wall from the same side as the projection that forms the thrust means (44), and wherein the normal distance between the upper edge of said wall and the axis of rotation of the rollers of the upper pair of rollers (42) increases from the lower blocking wall (40) to the upper blocking wall (45b).

9. Closing device according to claim 1, wherein the or each flexible wall (45, 45a) comprises at least one horizontal stiffener (46).

10. Closing device according to claim 9, wherein the or each stiffener (46) projects laterally beyond the corresponding flexible wall and engages in a dedicated pair of rails (32), common to all of the stiffeners, whereby each rail (32) comprises an essentially vertical lower rail segment (32a) that is extended by a horizontal or essentially horizontal upper rail segment (32b).

11. Closing device according to claim 8, wherein an elastic cable (60), attached to the horizontal upper and lower edges of this wall, is associated with each flexible blocking wall (45, 45a), whereby said elastic cable (60) rests on one of the surfaces of said wall and on the associated stiffener (46), said cable—at least in the extended position of the flexible wall (45), a position corresponding to the closing of the aperture—being extended between the upper and lower edges of said flexible wall (45).

12. Closing device according to claim 11, wherein the or each flexible wall (45, 45a) comprises at least one horizontal stiffener (46), which projects laterally beyond the corresponding flexible wall and engages in a dedicated pair of rails (32), common to all of the stiffeners, whereby each rail (32) comprises an essentially vertical lower rail segment (32a) that is extended by a horizontal or essentially horizontal upper rail segment (32b), and wherein the elastic cable (60) is attached to the stiffener (46) and the guide rail segments (30a, 32a) adopt a divergent spatial arrangement.

13. Device according to claim 1, wherein the or each rigid blocking wall (40, 45b) is formed by a rigid frame (40a, 45b) that comprises at least one horizontal longitudinal beam that occupies an upper position and two vertical lateral crosspieces that are attached to the longitudinal beam and that extend downward from the latter, whereby this rigid frame (40a, 45b) receives a filling wall (41, 45a).

14. Device according to claim 13, wherein the lower part of the rigid frame (40a) is formed by an elastic link, whereby the filling wall (41) is flexible and is attached to this elastic link (49).

15. Device according to claim 1, wherein the or each rigid wall (40, 45b) consists of at least two parts that are articulated to one another along a horizontal axis by a hinge system and wherein lateral guide rollers that are engaged in the rail pair (30) are arranged in the axis of the hinge.

16. Closing device according to claim 2, wherein the upper part (45) of the apron (4) is formed by a one-piece flexible wall.

17. Closing device according to claim 2, wherein the upper part (40) of the apron (4) is formed by at least two flexible blocking walls (45a) and by at least one rigid blocking wall (45b) that is inserted between the two flexible blocking walls (45a).

18. Closing device according to claim 9, wherein an elastic cable (60), attached to the horizontal upper and lower edges of this wall, is associated with each flexible blocking wall (45, 45a), whereby said elastic cable (60) rests on one of the surfaces of said wall and on the associated stiffener (46), said cable—at least in the extended position of the flexible wall (45), a position corresponding to the closing of the aperture—being extended between the upper and lower edges of said flexible wall (45).

19. Device according to claim 5, wherein the or each rigid wall (40, 45b) consists of at least two parts that are articulated to one another along a horizontal axis by a hinge system and wherein lateral guide rollers that are engaged in the rail pair (30) are arranged in the axis of the hinge.
